(19) United States
(12) Patent Application Publication
(10) Pub. No.: US 2026/0271844 A1
(43) Pub. Date: Sep. 17, 2026

(54) VERTICAL SELF-WATERING PLANTER WITH REMOVABLE PLANT HOLDERS

(71) Applicant: Arkeo LLC, SPOKANE, WA (US)

(72) Inventor: Farong Cheng, Seattle, WA (US)

(21) Appl. No.: 19/567,095

(22) Filed: Mar. 14, 2026

Related U.S. Application Data
(60) Provisional application No. 63/772,650, filed on Mar. 16, 2025.

(51) Int. Cl. A01G 27/06

(52) U.S. Cl. CPC A01G 27/06

(57) ABSTRACT

A vertical self-watering planter configured for indoor and space-efficient gardening is disclosed. The planter includes a frame supporting two or more removable plant holders arranged in a vertical configuration. Each plant holder is configured to directly receive potting mixture and a plant root system and may include perforations to promote aeration and moisture transfer. A water reservoir associated with the frame stores water and supplies moisture to the plant holders through a wicking fabric that transports water by capillary action without requiring electrical power. The reservoir may be integrally formed with the frame and may include a lid configured to guide water into the reservoir during filling. A water-level indicator may provide visual feedback regarding the water level within the reservoir. The planter may further include mounting features enabling free-standing placement or wall-mounted installation, thereby providing a compact, modular, and low-maintenance solution for plant cultivation.

### CROSS-REFERENCE TO RELATED PATENT DOCUMENTS

This patent application claims the benefit of priority of U.S. Provisional Application No. 63/772,650, entitled “Vertical Self-Watering Planter with Removable Plant Holders and Detachable Water Reservoir,” filed Mar. 16, 2025, which is hereby incorporated herein by reference in its entirety.

### TECHNICAL FIELD

This invention relates to horticultural devices, specifically, self-watering vertical planters designed for indoor and urban environments with limited space, providing a modular, low-maintenance solution for plant cultivation.

### BACKGROUND

Existing self-watering planters and vertical gardening systems commonly exhibit structural and functional limitations that reduce their suitability for indoor and urban environments with limited space. Many conventional systems are bulky or heavy due to multi-part constructions, separate reservoir assemblies, or reinforced housings, making them difficult to install or reposition in compact living areas. Maintenance of such systems can also be cumbersome, as integrated reservoirs or enclosed water chambers may be difficult to access and clean. In many cases, users must partially or completely disassemble the planter to remove accumulated debris, algae buildup, or pooled water, which increases maintenance effort and discourages regular upkeep. Additionally, numerous existing products provide limited configurational flexibility, often supporting only a single plant or offering fixed arrangements that do not easily adapt to varying spatial layouts or interior décor requirements. This lack of modularity restricts the ability to customize planting density or aesthetic presentation. Furthermore, traditional watering mechanisms in certain self-watering planters may deliver inconsistent moisture transfer, which can lead to overwatering or underwatering depending on environmental conditions and plant type. Such inefficient water management may negatively impact plant health and reduce the overall effectiveness of the planter system.

Accordingly, there remains a need for a simplified vertical self-watering planter that reduces bulk and structural complexity, simplifies maintenance access, supports modular multi-plant configurations, and provides reliable capillary-based water delivery for consistent plant hydration.

### SUMMARY

In various aspects, the present invention discloses a vertical self-watering planter. The vertical self-watering planter includes a frame defining a vertical structure configured to support one or more plants; two or more removable plant holders supported by the frame, each plant holder defining a container configured to receive potting mixture and a plant root system; a water reservoir associated with the frame and configured to store water for supplying to the two or more plant holders; a wicking fabric extending between the water reservoir and the two or more plant holders and configured to transport water from the water reservoir to the potting mixture by capillary action; and a mounting structure associated with the frame that enables the planter to be positioned on a surface or mounted to a vertical support, wherein the planter provides passive water delivery to plants without electrical power.

In various aspects, the water reservoir is integrally formed with the frame.

In various aspects, the water reservoir is constructed from an opaque material configured to inhibit algae growth.

In various aspects, the planter further comprising a lid positioned over the water reservoir and configured to direct water toward the wicking fabric during filling.

In various aspects, the lid includes a reduced opening configured to provide controlled water flow into the water reservoir.

In various aspects, the lid comprises a buoyant float element hole; and an indicator head hole.

In various aspects, the planter further comprises a water level indicator configured to provide visual feedback of a water level within the water reservoir.

In various aspects, the water level indicator comprises: an indicator head; an indicator stem coupled to the indicator head; and an indicator buoyant float element coupled to the indicator stem, wherein the indicator buoyant float element and the indicator head are configured to move relative to each other based on a level of water in the water reservoir, and wherein the indicator head is raised to a maximum height through the indicator head hole of the lid when the water reservoir is empty, and the indicator buoyant float element is raised to a maximum height through the buoyant float element hole of the lid when the water reservoir is full.

In various aspects, the wicking fabric is secured within the frame by recessed channels or structural slots formed in the frame.

In various aspects, a portion of the wicking fabric extends into the two or more plant holders to maintain contact with the potting mixture.

In various aspects, each plant holder includes perforations configured to permit aeration and moisture transfer.

In various aspects, the two or more plant holders are removably secured to the frame using locking bumps or engagement features.

In various aspects, the frame includes a bump-out structure configured to support the two or more plant holders at an outwardly angled orientation.

In various aspects, the mounting structure comprises: a wall-engagement slot formed in the frame; and a wall hook configured to engage the slot.

In various aspects, the wall hook comprises a bubble level configured to assist with alignment during installation.

In various aspects, the wall hook includes a contoured engagement surface configured to improve stability when the planter is mounted.

In various aspects, the frame is configured to support two or more vertically arranged two or more plant holders.

In various aspects, the water reservoir is detachable from the planter.

The planter supports free-standing and wall-mounted use, with a wall hook slot, handle hole, and wall hook with a built-in bubble level for precise installation.

The invention provides a unitary frame structure that offers structural support and durability while simplifying manufacturing and assembly and reducing overall weight.

Additional features include plant holder lock bumps arranged on opposite sides to secure the holders, a reservoir lid for easy access with a reduced opening configured to maintain smooth and controlled water flow, and a refined wall-hanging hook shape to improve fit and usability, all contributing to a robust and space-efficient design.

### BRIEF DESCRIPTION OF THE DRAWINGS

FIG. 1 illustrates a top left perspective view of the vertical self-watering planter.

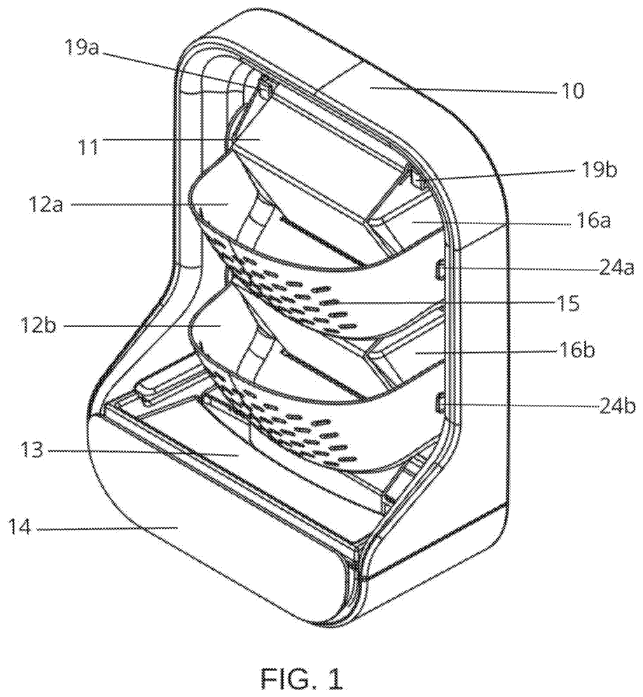

FIG. 2 illustrates a rear view of the vertical self-watering planter showing the frame and wall-hanging slot.

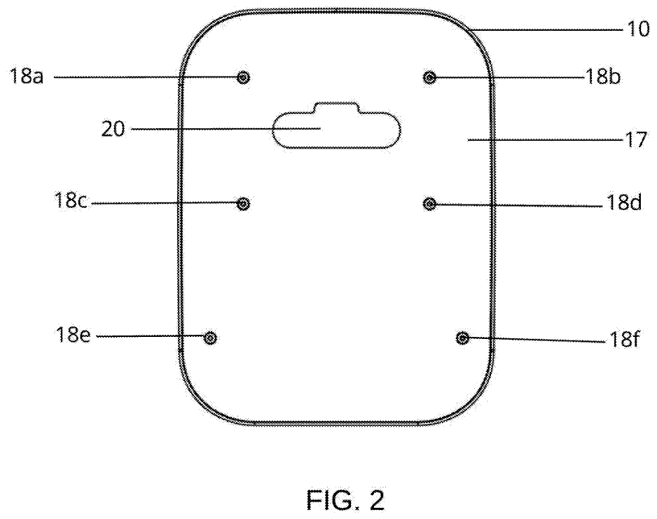

FIG. 3 illustrates a bottom left perspective view of the vertical self-watering planter.

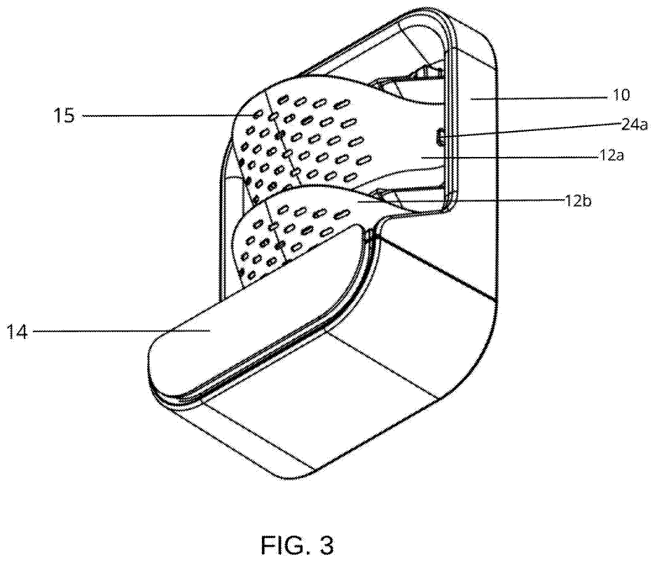

FIG. 4 illustrates a left side view of the vertical self-watering planter showing the arrangement of the plant holders within the frame.

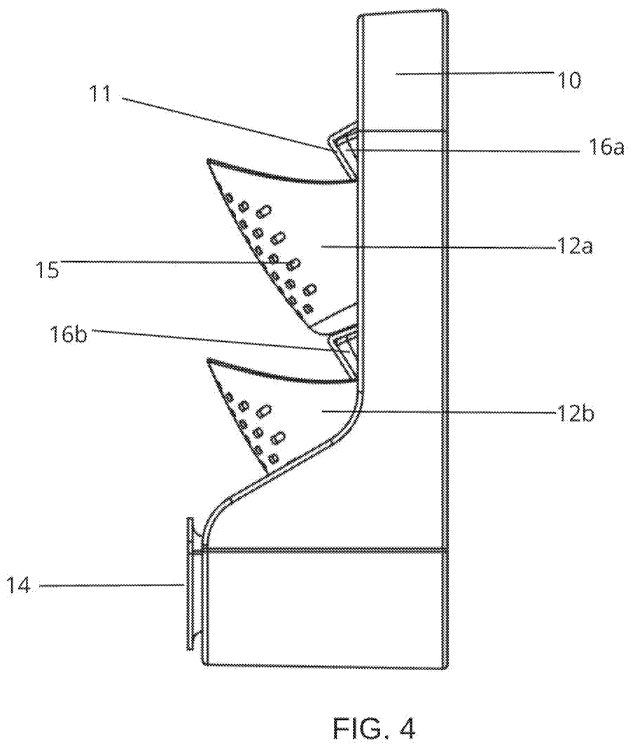

FIG. 5 illustrates a back left perspective view of the vertical self-watering planter.

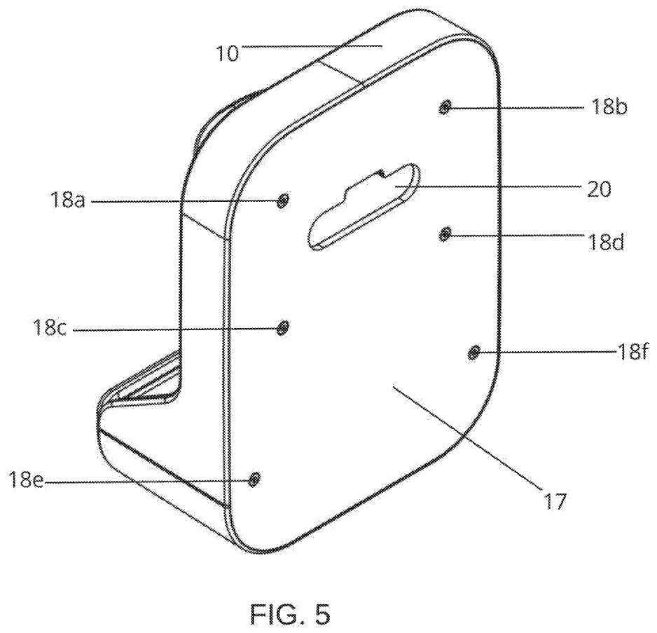

FIG. 6 illustrates a bottom view of the vertical self-watering planter.

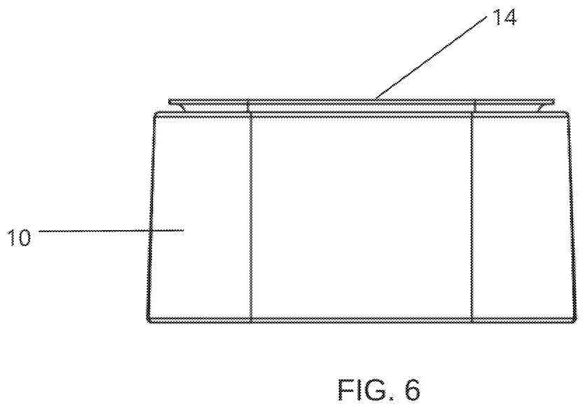

FIG. 7 illustrates a top view of the vertical self-watering planter.

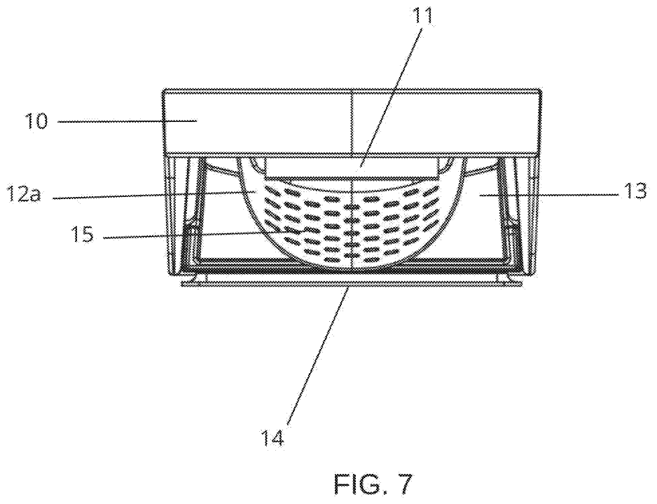

FIG. 8 illustrates a right side view of the vertical self-watering planter.

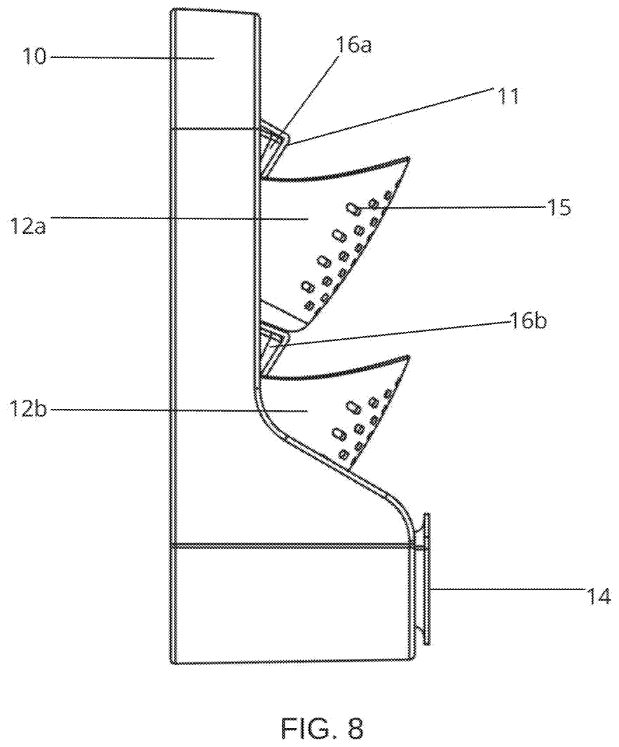

FIG. 9 illustrates a front view of the vertical self-watering planter.

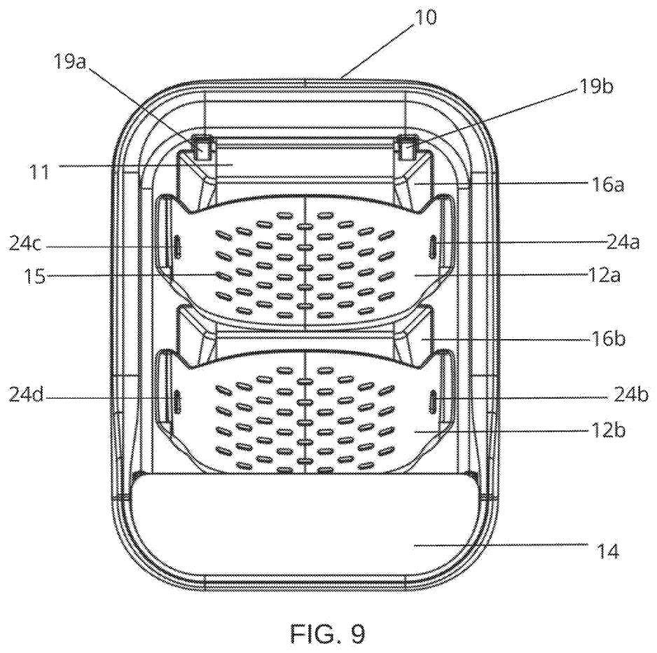

FIG. 10 illustrates a top right perspective view of the vertical self-watering planter.

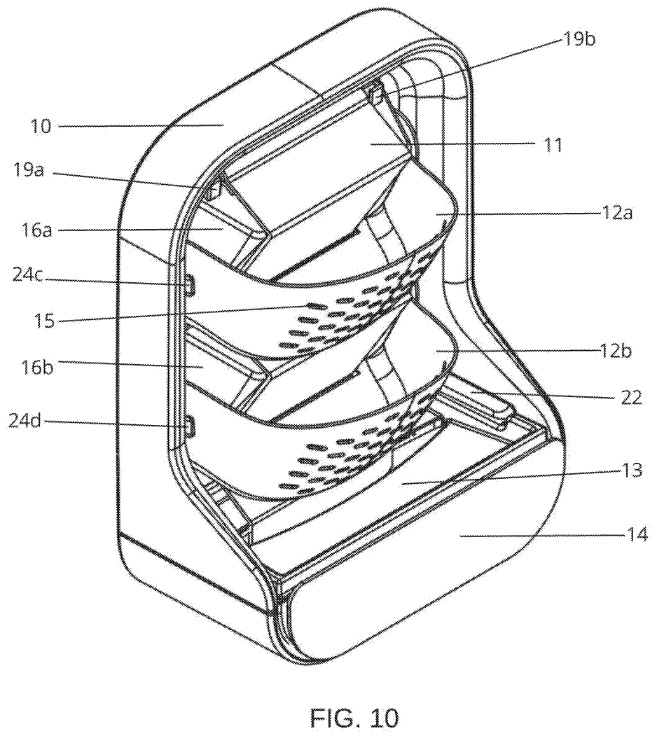

FIG. 11 illustrates a bottom right perspective view of the vertical self-watering planter.

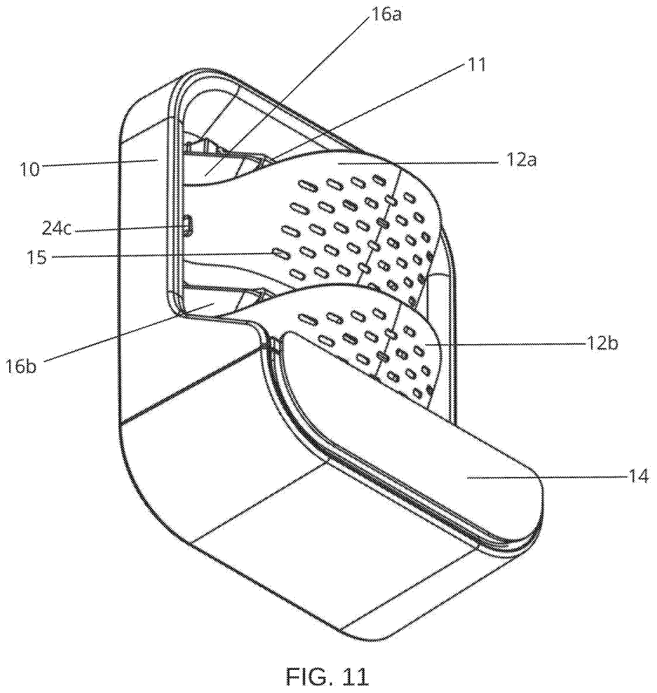

FIG. 12 illustrates an exploded view of the vertical self-watering planter showing the frame, plant holders, wicking fabric, reservoir lid, and associated structural components.

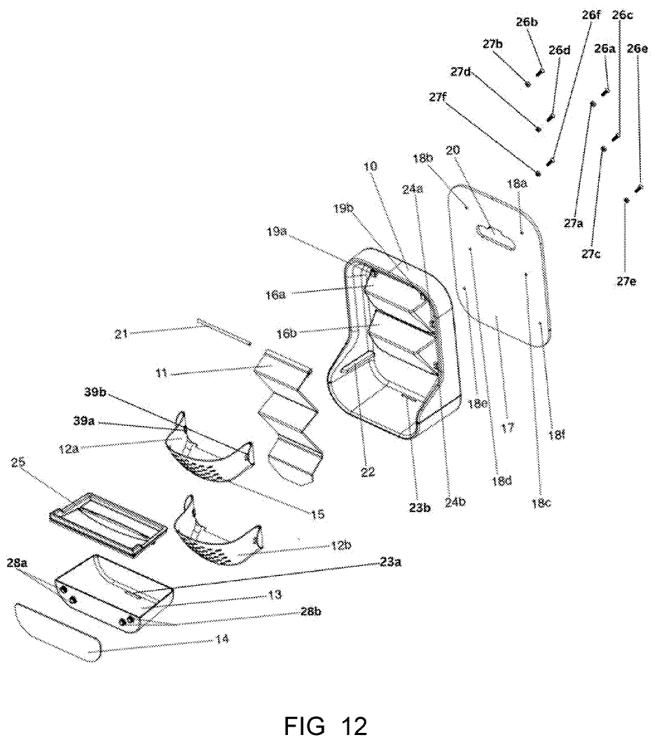

FIG. 13 illustrates a sectional side view of the planter showing the internal arrangement of the plant holders, wicking fabric, and water reservoir.

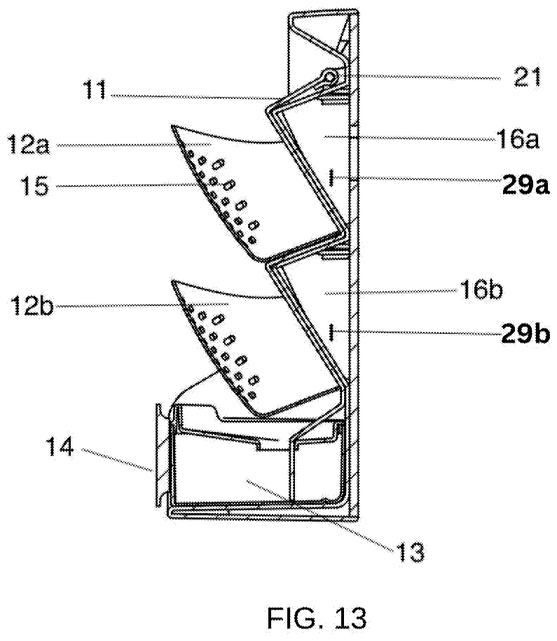

FIG. 14 illustrates a top view of the wall hook used for mounting the planter to a vertical surface.

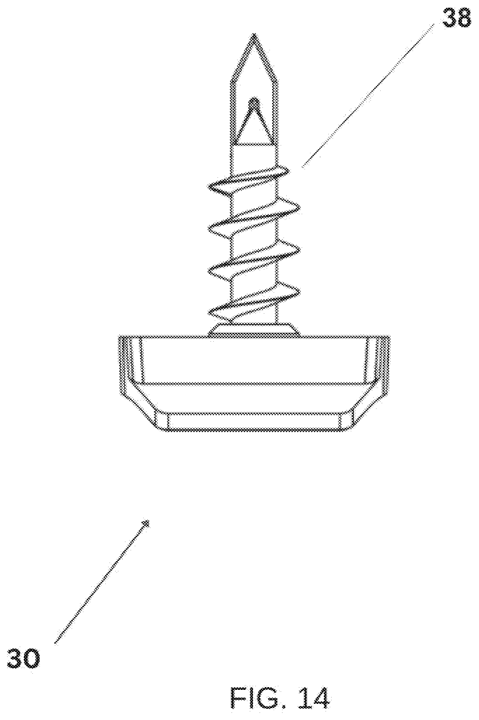

FIG. 15 illustrates a left side view of the wall hook.

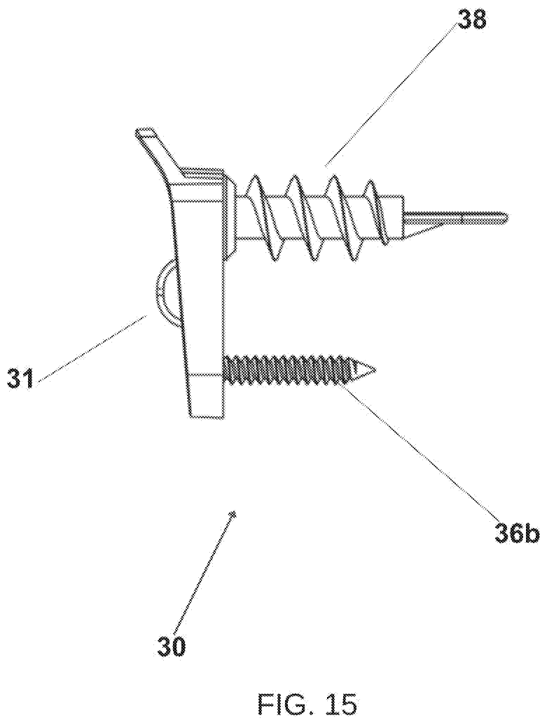

FIG. 16 illustrates a right-side view of the wall hook.

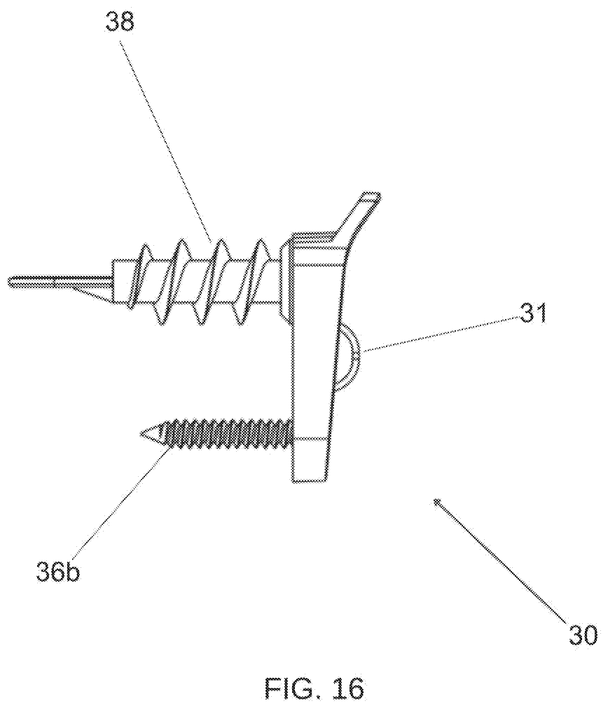

FIG. 17 illustrates a front view of the wall hook.

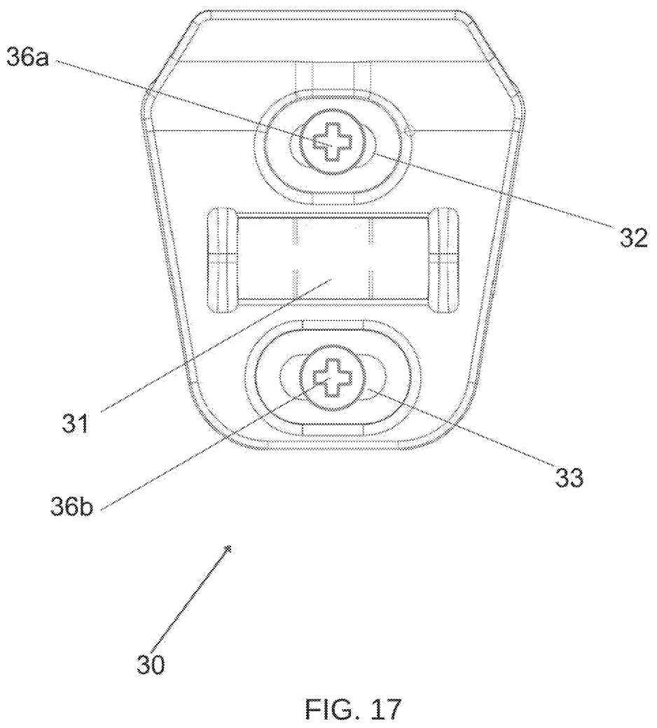

FIG. 18 illustrates a bottom view of the wall hook.

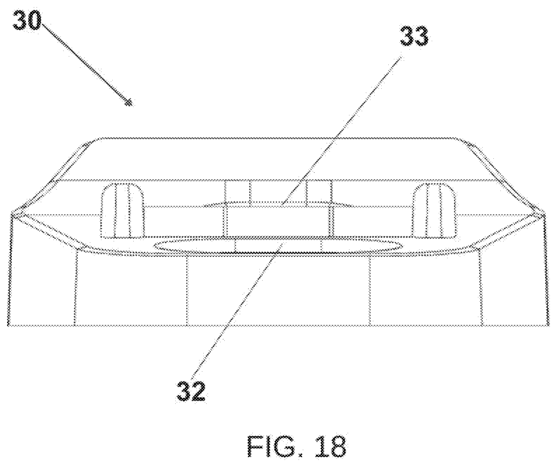

FIG. 19 illustrates a back view of the wall hook showing the hook engagement features.

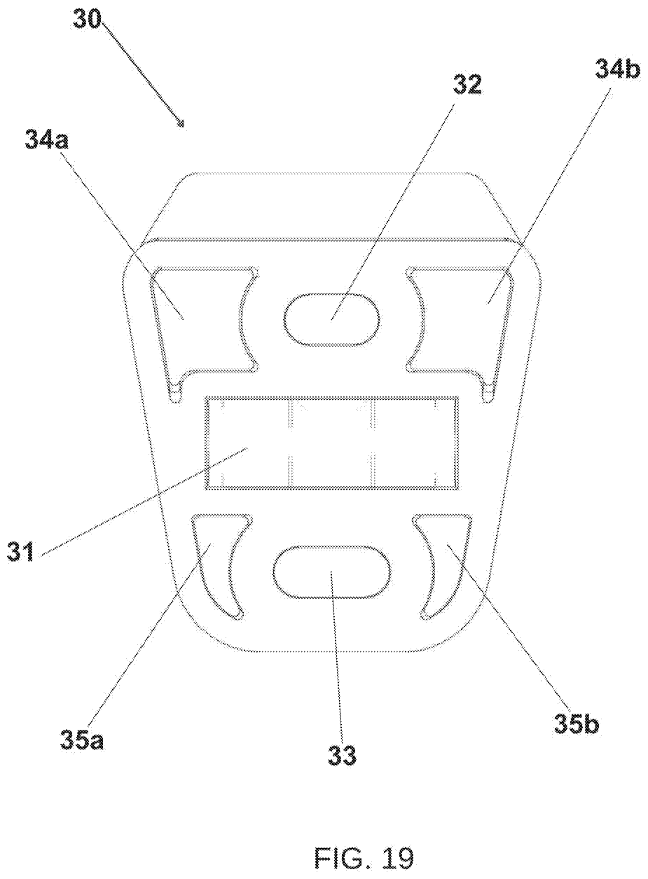

FIG. 20 illustrates an exploded view of the wall hook assembly including screws, anchor, and bubble level components.

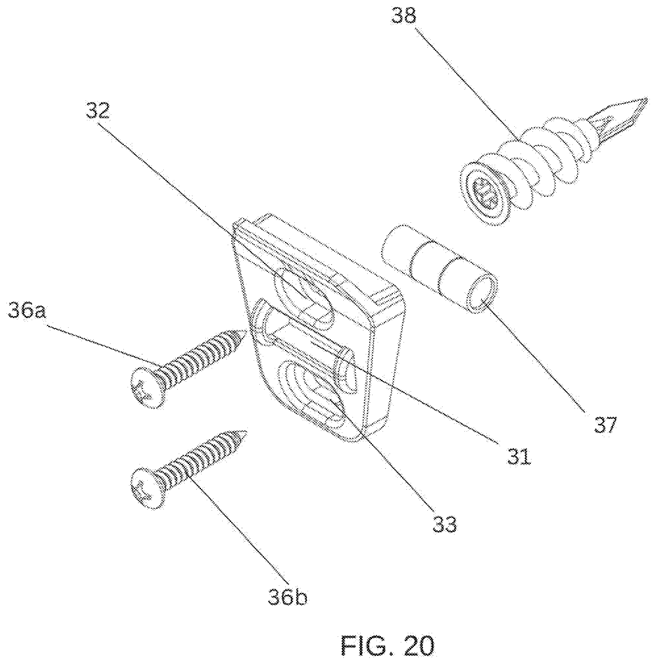

FIG. 21 illustrates plan views of a flexible fabric component used in the planter system.

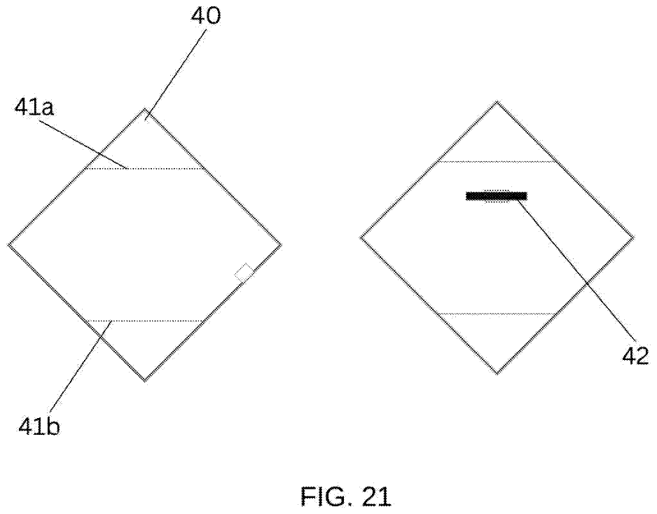

FIG. 22 illustrates side and sectional views of the flexible fabric component.

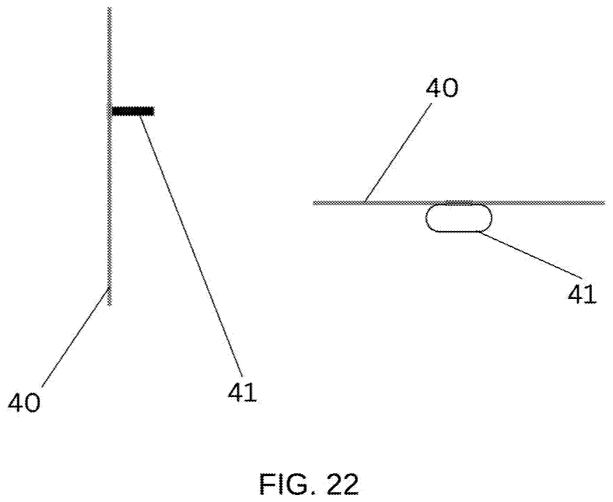

FIG. 23 illustrates an exploded view of another embodiment of the planter assembly including the frame, plant holders, wicking fabric, reservoir lid, and water level indicator components.

FIG. 24 illustrates a perspective view of the water level indicator assembly.

FIG. 25 illustrates front and sectional views of the planter showing the internal arrangement of the plant holders and water reservoir.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event, such a component or process is described, but not depicted in a drawing, the absence of such component and process from the drawings should not be considered as an omission of such design from the specification.

Before describing the present invention in detail, it should be observed that the present invention utilizes a combination of components or processes, which constitute a vertical self-watering planter with removable plant holders. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

The following detailed description illustrates the different embodiments of the invention for illustrative purposes only. It should be understood that the described embodiments are merely exemplary and that modifications, substitutions, and variations may be made without departing from the scope of the invention as defined by the appended claims. References to specific configurations, materials, or features are intended to provide a clear understanding of the invention but should not be construed as limiting. The invention will be further described with reference to the accompanying drawings, in which like reference numerals indicate corresponding elements throughout.

The invention is a vertical self-watering planter that incorporates a modular design to facilitate easy maintenance, cleaning, and versatile installation. The device is particularly suited for urban indoor gardening, where space is limited. The planter includes removable plant holders (12a, 12b), a water reservoir (13), a wicking system (11), a handle hole (20), and front (14) and back (17) panels. The planter's frame (10) provides structural support. In certain embodiments, the front panel (14) and back panel (17) may be omitted and the frame (10) may be formed as a unitary molded structure that provides the necessary structural enclosure and support. In further embodiments, the water reservoir (13) may be formed as a detachable component as illustrated, or alternatively may be integrally formed with the frame (10) as part of a single molded structure that defines the water storage region of the planter.

The plant holders (12a, 12b) are composed of durable, lightweight materials and feature perforations (15) to enhance aeration. In one embodiment, the planter comprises two plant holders (12a, 12b); however, additional holders of varying sizes or designs may be incorporated as required. In certain embodiments the plant holders (12a, 12b) are configured to directly receive potting mixture and plant roots, allowing plants to be placed directly within the plant holders (12a, 12b) without the use of a separate containment structure. The number, size, and arrangement of perforations (15) may vary depending on the intended plant type and desired moisture transfer characteristics.

Each plant holder is secured by lock bumps (24a-d), with (24a) and (24b) on the right side and (24c) and (24d) on the left, ensuring a stable and secure fit. Adjacent to the bump locks, a negative area designated 29a-b is provided. This area serves no functional locking purpose but is included solely to ensure the part maintains a uniform wall thickness during molding. Additionally, plant holder lock holes, designated 39a-b, are incorporated to interface with the bump locks, ensuring secure alignment of the plant holders. In certain embodiments the geometry of the lock bumps and corresponding holder engagement features may be modified to improve insertion and removal of the plant holders while maintaining secure retention during operation.

The detachable water reservoir (13) is designed for easy cleaning and maintenance, made from opaque material to prevent algae growth. The front panel (14) creates side gaps, allowing users to check the water level at a glance without a separate indicator. Additionally, the reservoir includes a lid (25) with a front grip for effortless removal. In alternative embodiments, the reservoir (13) may be formed integrally with the frame (10), thereby eliminating the need for removal while still allowing water to be introduced through the lid or opening. In certain embodiments the planter may further include a water level indicator assembly configured to provide visual feedback regarding the water level within the reservoir.

The reservoir (13) is guided into position by a reservoir guide rib (22), ensuring proper alignment. A reservoir lock bump (23a) secures it in place and is configured to engage with a corresponding lock recess (23b) on the inner surface of the frame. In embodiments where the reservoir is integrally formed with the frame (10), the guide ribs (22) may instead function as internal reinforcement features or structural elements that help define the reservoir cavity.

The reservoir lid (25) features a funnel-shaped design that directs water onto the wicking fabric (11) without splashing, while its front grip allows for easy removal. In certain embodiments the reservoir lid (25) may include a reduced opening configured to allow controlled water flow into the reservoir while minimizing debris entry and water splashing.

The front panel (14) is glued to the reservoir attachment bosses (28a, 28b), reinforcing the frame (10) and enhancing aesthetics. The back panel (17) is fastened with screws (26a-f) and washers (27a-f), providing additional structural durability. In certain embodiments, the front and back panels may be omitted, and the frame (10) may instead be manufactured as a single-piece structure that integrates the functional features of the planter while reducing manufacturing complexity and overall weight.

The wicking system (11) features a customized synthetic fabric that efficiently delivers water to plant roots through capillary action for approximately 2-3 weeks. The fabric hanging bar (21) ensures proper alignment and consistent absorption, securely held in place by the left (19a) and right (19b) fabric hanging bar slots to prevent movement. Designed for adaptability, the system supports water distribution to two or more plant holders, with the capacity to accommodate additional holders as needed. In addition to the wicking system, the present invention includes a specialized root wrapper (40) designed to securely contain and protect the plant's root ball. The root wrapper (40) features a diamond-shaped sheet with two folding lines (41a, 41b) at opposite corners for easy folding and an elastic fastening band (42). It is preferably made from the same custom synthetic fabric as the wicking system, providing optimal aeration and moisture retention. In certain embodiments the wicking fabric may alternatively be retained directly within recessed channels or structural slots formed in the frame (10), eliminating the need for a separate hanging bar while maintaining contact between the wicking fabric and the reservoir. In further embodiments plants may be placed directly within the plant holders using potting mixture, thereby eliminating the need for the root wrapper.

The present invention also features a wall hook slot and handle hole (20) on the back panel (17), and a wall hook (30) with a built-in bubble level (37) for precise wall installation. The wall hook (30) further comprises a drywall anchor (38), a top screw (36a), a bottom screw (36b), a bubble level housing (31), a top hook screw hole (32), and a bottom hook screw hole (33). In addition, two sets of hook negative spaces for molding are provided, designated as 34a-b and 35a-b. These recesses are incorporated solely to ensure the part maintains a uniform wall thickness during molding and are not critical to the functional performance of the wall hook. In certain embodiments the shape or contour of the wall hook may be refined to improve engagement with the wall hook slot and to enhance mounting stability.

### Assembly and Operation

To assemble the planter, the front panel (14) is glued to the attachment bosses (28a, 28b) of the water reservoir (13), while the back panel is secured using screws (26a-f) and washers (27a-f). Both panels are pre-assembled during manufacturing for structural integrity, with the remaining assembly steps to be completed by the user. In certain embodiments, the front panel (14) and back panel (17) may be omitted and the frame (10) may instead be formed as a unitary molded structure that provides structural support without separate panels. In further embodiments the water reservoir (13) may be removably positioned within the frame as illustrated, or may alternatively be integrally formed with the frame (10) as part of a single molded structure.

The wicking fabric (11) is installed on the fabric hanging bar (21), maintaining contact with the water reservoir (13) for effective capillary action, while the left (19a) and right (19b) fabric hanging bar slots secure the bar, preventing shifting. In certain embodiments the wicking fabric (11) may alternatively be retained directly within recessed channels, slots, or molded retaining structures formed in the frame (10), thereby eliminating the need for a separate hanging bar while maintaining proper positioning of the wicking fabric relative to the water reservoir (13).

The top (12a) and bottom (12b) plant holders are inserted into designated slots, while the plant holder lock bumps (24a-24d) and bump-outs (16a, 16b) secure and support the holders. The plant holders (12a, 12b) are configured to receive plants and associated growing medium. In certain embodiments the plant holders (12a, 12b) may directly contain potting mixture and plant roots, allowing plants to be placed directly within the holders while still enabling moisture transfer from the wicking fabric.

The reservoir lid (25), featuring a funnel-shaped design for controlled water flow, is placed first. Next, the water reservoir (13) is positioned, aligning with the reservoir guide ribs (22) for a secure fit, while the reservoir lock bump (23a) keeps it firmly in place. In embodiments in which the reservoir (13) is integrally formed with the frame (10), the guide ribs (22) may instead define structural reinforcement features within the reservoir cavity. In certain embodiments the lid (25) may include a reduced opening configured to allow controlled water flow into the reservoir while minimizing splashing and debris entry.

For wall-mounted installations, the planter is securely attached using the wall hook slot and handle hole (20). The process begins by drilling a hole for a drywall anchor and inserting the wall hook. The top screw (36a) is tightened first, after which the built-in bubble level (37) assists in aligning the planter horizontally. Once properly positioned, the bottom screw (36b) is fastened, ensuring a stable and level installation. In certain embodiments the geometry of the wall hook (30) may be refined or contoured to improve engagement with the wall hook slot and enhance mounting stability.

Before placing a plant into the planter, the root wrapper (40) is used to securely contain the plant's root ball, ensuring protection and ease of handling. The process begins by laying the root wrapper (40) flat on a surface. With the aid of the two folding lines (41a, 41b), the top corner is folded downward to create a containment pocket for the plant's roots. Once the plant is positioned within the pocket, the bottom corner is folded upward, partially enclosing the root system for added stability and protection. To reinforce stability, the bottom edge is folded upward again. The left corner is then folded over the enclosed root ball, followed by the right corner, which overlaps to secure the structure. The elastic fastening band (41) is applied to keep the wrapper intact. This method prevents soil displacement while maintaining a breathable structure, facilitating smooth transplantation into the planter. In certain embodiments plants may alternatively be placed directly within the plant holders using potting mixture without the use of the root wrapper (40).

To start, add water to the detachable reservoir (13), where the wicking fabric (11) efficiently draws moisture upward, sustaining plants for 2-3 weeks. Side gaps in the front panel (14) provide a clear view of the water level without requiring a separate indicator. Since the root wrapper (40) is made from the same customized synthetic fabric as the wicking system, it also absorbs moisture, ensuring direct hydration to the plant's roots. Regular maintenance is simple, as the removable water reservoir (13) allows for effortless cleaning, while all components are designed for easy access and reassembly. In certain embodiments the planter may further include a water level indicator assembly configured to provide visual feedback regarding the amount of water present in the reservoir during operation.

### Embodiments and Variations

The planter is designed with versatility, allowing different configurations to suit various spaces and preferences. The structural arrangement of the frame (10), plant holders (12a, 12b), water reservoir (13), and wicking system (11) allows the planter to be used in multiple configurations while maintaining the self-watering functionality. In certain embodiments the planter may include additional structural elements such as front (14) and back (17) panels, while in other embodiments the frame (10) may be formed as a unitary structure that integrates the functional features of the planter.

### Free-Standing Configuration

The planter remains stable on flat surfaces, making it ideal for indoor use. The reservoir guide ribs (22) and lock bump (23a) secure the water reservoir (13), preventing movement. The front (14) and back (17) panels provide structural support for durability. In certain embodiments the frame (10) itself may provide sufficient structural rigidity without the use of separate panels. In further embodiments the water reservoir (13) may be removably positioned within the frame or integrally formed as part of the frame structure while still enabling water storage and delivery through the wicking system (11).

### Wall-Mounted Configuration

The planter can be mounted on vertical surfaces using the wall hook slot and handle hole (20). A built-in bubble level (37) ensures proper alignment, while screws (26a-f) and washers (27a-f) secure it in place, maximizing space efficiency. In certain embodiments the wall hook (30) may include a contoured engagement profile that improves fit and stability when the planter is mounted. The wall-mounted configuration allows the planter to function as a vertical gardening system while maintaining passive irrigation through the reservoir (13) and wicking system (11).

### Multi-Plant Holder Configuration

The planter supports multiple plant holders (12a, 12b), with the option to add more as needed, increasing planting capacity while preserving the self-watering function. The fabric hanging bar (21) and slots (19a, 19b) ensure consistent water distribution, while the reservoir guide ribs (22) maintain structural stability. In certain embodiments the wicking fabric may alternatively be retained directly within recessed channels or structural slots formed in the frame (10), eliminating the need for the hanging bar while maintaining effective moisture transfer. In further embodiments plants may be positioned directly within the plant holders using potting mixture without requiring a root wrapper, allowing the planter to support a variety of planting configurations.

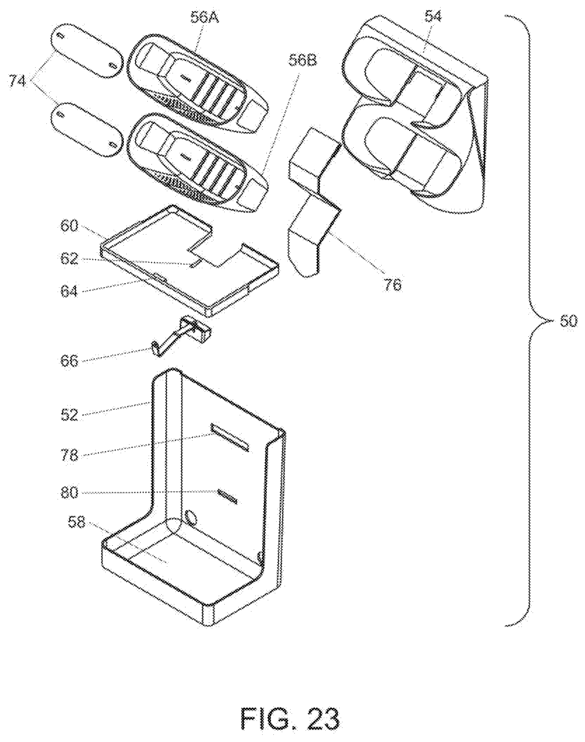

FIG. 23 illustrates an exploded perspective view of another embodiment of the planter assembly such as the vertical self-watering planter (50), showing the structural relationship between the planter frame (52), plant holders (56A, 56B), water reservoir (58), lid (60), water level indicator assembly (66), pot fabric (74), and wicking fabric (76). The planter frame (52) provides structural support for the planter (50) and defines an interior region configured to receive the plant holders (56A, 56B) and the water reservoir (58).

The plant holders include an upper plant holder (56A) and a lower plant holder (56B), each configured to receive potting mixture and plant roots. The plant holders (56A, 56B) may include perforations (68) formed along sidewalls and bottom surfaces to facilitate aeration and moisture transfer. In certain embodiments the plant holders (56A, 56B) may also include locking structures such as upper lock bumps (70A, 70B) and lower lock bumps (72A, 72B), which cooperate with corresponding portions of the planter frame (52) to retain the plant holders (56A, 56B) within the planter.

The planter frame (52) further includes structural features such as bump-out portions (54) that assist in positioning or supporting the plant holders (56A, 56B). In certain embodiments the bump-out portions (54) may provide additional spacing or structural reinforcement within the frame (52) while facilitating engagement between the plant holders (56A, 56B) and the planter frame (52).

The water reservoir (58) is positioned within a lower portion of the planter frame (52) and is configured to store water used by the self-watering system. The reservoir (58) is arranged such that a wicking fabric (76) extends from the water reservoir (58) toward the plant holders (56A, 56B). Through capillary action, water stored within the water reservoir (58) is transferred upward through the wicking fabric (76) and delivered to potting mixture within the plant holders (56A, 56B).

A pot fabric (74) may be positioned within the plant holders (56A, 56B) to assist with moisture distribution and retention while permitting aeration of plant roots. The pot fabric (74) may contact the wicking fabric (76) so that water transferred through the wicking fabric (76) is delivered to the potting mixture contained within the plant holders (56A, 56B).

The water reservoir (58) is covered by a lid (60) positioned along an upper portion of the water reservoir (58). The lid (60) may include openings configured to allow observation of a water level indicator assembly (66). In certain embodiments the lid (60) includes a buoyant float element hole (62) and an indicator head hole (64).

The water level indicator (66) provides visual feedback regarding the amount of water present within the reservoir (58). The water level indicator (66) may include an indicator head (66A), an indicator stem (66B), and an indicator buoyant float element (66C). The indicator stem (66B) extends between the indicator head (66A) and the indicator buoyant float element (66C) such that movement of the indicator buoyant float element (66C) within the water reservoir (58) causes corresponding movement of the indicator head.

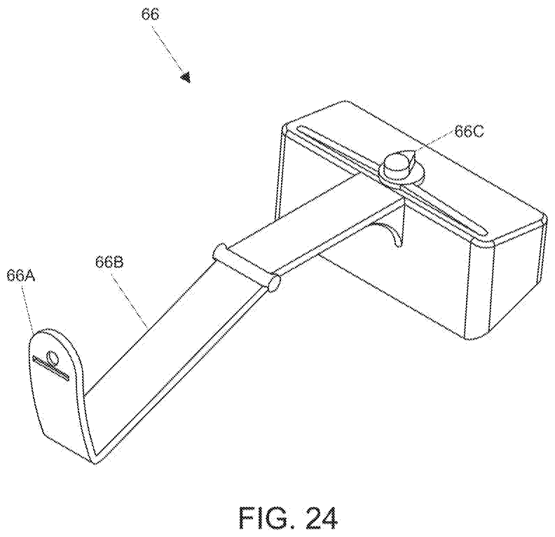

FIG. 24 illustrates the water level indicator (66) removed from the planter to show the relationship between the indicator head (66A), the indicator stem (66B), and the indicator buoyant float element (66C). The indicator buoyant float element (66C) is configured to float within water contained in the water reservoir (58). As the water level within the water reservoir (58) changes, the indicator buoyant float element (66C) moves vertically, thereby translating motion through the indicator stem (66B) to the indicator head (66A).

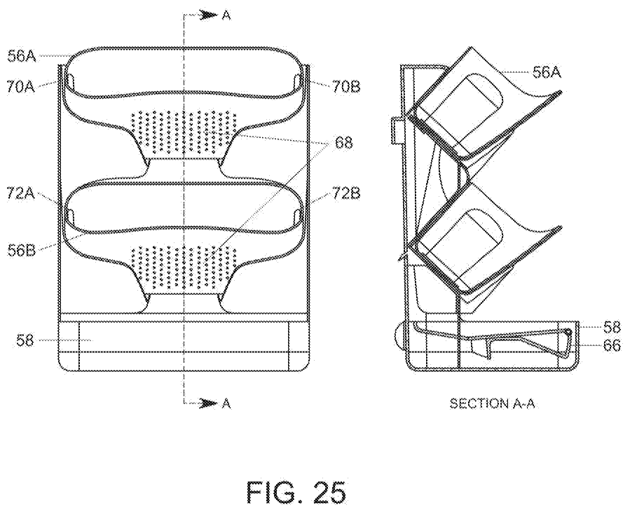

FIG. 25 illustrates the assembled planter (50) showing the operation of the water level indicator (66) relative to the lid (60). When the water reservoir (58) contains little or no water, the buoyant float element (66C) occupies a lower position within the reservoir. In this condition the water level indicator head (66A) is visible through the water level indicator head hole (64) of the lid (60), indicating that the water level is low.

When water is added to the water reservoir (58), the indicator buoyant float element (66C) rises due to buoyancy. As the indicator buoyant float element (66C) rises, the water level indicator (66) moves relative to the lid (60). When the water reservoir (58) reaches a full condition, the buoyant float element (66C) becomes visible through the water level full indicator hole (62) of the lid (60), thereby indicating that the water reservoir (58) is full.

The water level indicator (66) therefore enables users to visually determine the level of water contained within the water reservoir (58) without requiring removal of the lid (60) or disassembly of the planter (50). The indicator system operates passively and does not require electrical sensors or external power.

Although particular configurations of the water level indicator (66), lid openings (such as 62, 64), and float element (66C) are illustrated, alternative indicator arrangements may be used to provide visual indication of reservoir water level without departing from the scope of the invention.

The present invention provides several significant advantages over conventional self-watering planters used in indoor and urban gardening environments. Conventional planters are often bulky or heavy due to multi-part constructions and separate reservoir assemblies, which limit their suitability for compact spaces and complicate installation or repositioning. Additionally, many traditional systems require partial or complete disassembly to access and clean enclosed reservoirs, particularly when addressing algae buildup or water pooling. As a result, such planters frequently involve increased maintenance effort and reduced usability over extended use. The present invention provides a simplified planter architecture in which multiple functional components are integrated into a compact structure, thereby reducing structural complexity while maintaining effective watering functionality.

The present invention directly addresses these shortcomings by integrating the water reservoir within the frame and employing removable plant holders configured to directly contain potting mixture and plant roots. Unlike prior systems that rely on auxiliary liners, root wrappers, detachable reservoir assemblies, or complex wick-support structures, the invention allows moisture transfer to occur through a wicking fabric positioned within the planter structure. In certain embodiments the wicking fabric may be retained within recessed channels or structural slots formed in the frame, thereby establishing a stable capillary pathway between the reservoir and the plant holders. By maintaining moisture contact between the wicking fabric and the potting mixture contained within the plant holders, the invention enables consistent hydration of plants while simplifying planting and assembly operations.

A further advantage of the invention is the simplified structural configuration of the frame that reduces overall weight and structural complexity while maintaining adequate durability for indoor or vertical installation. In some embodiments the frame may include integrated structural features that reduce the need for multiple independent components. This integrated architecture enhances durability, minimizes potential leak paths, and simplifies manufacturing while maintaining a compact vertical footprint suitable for indoor environments. The simplified construction also allows the planter to be partially or fully assembled during production, enabling users to perform planting and routine maintenance without requiring specialized tools or extensive disassembly.

The invention also improves configurational versatility by supporting multiple removable plant holders within a single vertical structure. This modular arrangement enables users to cultivate more than one plant within a compact footprint and adapt the planting configuration to different spatial layouts or aesthetic preferences. The plant holders may be arranged in vertically spaced positions and may include perforations that facilitate aeration and moisture transfer while allowing the holders to securely retain potting mixture.

Additionally, the planter may include a reservoir lid configured to facilitate controlled filling of the water reservoir. In certain embodiments the lid may include a reduced opening or funnel-shaped profile that directs water toward the reservoir while minimizing splashing or debris ingress. The planter may further include a water-level indicator associated with the reservoir to provide visual feedback regarding the amount of water present within the reservoir. In some embodiments the water-level indicator may include a buoyant float element connected to an indicator head through a stem, allowing the indicator to move relative to openings formed in the lid so that different indicator elements become visible as the water level changes.

Collectively, these features provide a structurally simplified, lightweight, and low-maintenance vertical self-watering planter that (i) reduces bulk and assembly complexity, (ii) simplifies reservoir access and cleaning, (iii) supports modular multi-plant configurations within a compact structure, (iv) provides visual feedback of reservoir water level, and (v) ensures reliable capillary-based water delivery for consistent plant hydration. The present invention therefore overcomes the usability, maintenance, and configurational limitations of prior self-watering planters while remaining well-suited for modern indoor and urban gardening applications.

Although particular embodiments of the invention have been described in detail for purposes of illustration, various modifications and enhancements may be made without departing from the spirit and scope of the invention.

### Definitions and Technical Terms

For the purposes of this application, the following definitions and clarifications apply:
Planter—A container or structure designed to hold plants and soil, featuring a modular, self-watering system for efficient plant care.
Self-watering—A system by which water is delivered to plant roots via capillary action without manual intervention.
Capillary Action—The movement of water within a narrow space due to adhesive and cohesive forces, allowing for passive moisture transfer.
Wicking Fabric—A synthetic, mold-resistant material engineered to transport water through capillary action, ensuring consistent hydration of plant roots.
Plant Holder—A removable compartment designed to secure and support plant growth while allowing for air circulation and proper drainage.
Water Reservoir—A container that stores water and provides a sustained water supply to the planter through capillary action.
Opaque—Not permitting light to pass through, thereby reducing algae growth and minimizing water evaporation.
Modular—Consisting of interchangeable or removable parts that can be independently assembled, replaced, or customized.
Plant Holder Perforations—Small openings in the plant holders that allow for air circulation and excess water drainage to promote healthy root development.
Water reservoir Guide Ribs—Internal ridges within the planter that stabilize the water reservoir, ensuring a secure fit.
Wall Hook Slot and Handle Hole—A dual-purpose cutout that facilitates wall mounting and allows for easy transportation.
Built-in Bubble Level—An integrated leveling tool that assists in proper planter alignment during wall installation.
Multi-Plant Holder Configuration—A design variation that includes two or more plant holders while maintaining the same self-watering functionality.
Frame—A structural body of the planter that supports and retains internal components including plant holders, the water reservoir, and the wicking system.
Lid—A cover positioned above the water reservoir that permits filling of the reservoir while protecting the interior components of the planter.
Water Level Indicator—A visual indication mechanism configured to provide feedback regarding the amount of water present in the water reservoir.
Indicator Head—A visible portion of the water level indicator that moves relative to an opening in the lid to indicate a water level condition.
Indicator Stem—An elongated connector that links the water level indicator head to the buoyant float element and transmits vertical movement caused by changes in water level.
Indicator Buoyant Float Element—A floating component positioned within the water reservoir that rises or falls with changes in water level.
Buoyant Float Element Hole—An opening formed in the lid through which the indicator buoyant float element becomes visible when the water reservoir reaches a full water level.
Indicator Head Hole—An opening formed in the lid through which the water level indicator head is visible when the water reservoir is empty or at a low water level.
Integrated Water Reservoir—A reservoir that is formed as part of or permanently positioned within the frame of the planter rather than being fully removable.
Recessed Wicking Fabric Retention—A structural feature of the frame that secures the wicking fabric within channels or slots without requiring a separate support bar.

What is claimed is:

1. A vertical self-watering planter comprising:
a frame defining a vertical structure configured to support one or more plants;
two or more removable plant holders supported by the frame, each plant holder defining a container configured to receive potting mixture and a plant root system;
a water reservoir associated with the frame and configured to store water for supplying to the two or more plant holders;
a wicking fabric extending between the water reservoir and the two or more plant holders and configured to transport water from the water reservoir to the potting mixture by capillary action; and
a mounting structure associated with the frame that enables the planter to be positioned on a surface or mounted to a vertical support,
wherein the planter provides passive water delivery to plants without electrical power.

2. The planter of claim 1, wherein the water reservoir is integrally formed with the frame.

3. The planter of claim 1, wherein the water reservoir is constructed from an opaque material configured to inhibit algae growth.

4. The planter of claim 1, further comprising a lid positioned over the water reservoir and configured to direct water toward the wicking fabric during filling.

5. The planter of claim 4, wherein the lid includes a reduced opening configured to provide controlled water flow into the water reservoir.

6. The planter of claim 4, wherein the lid comprises:
a buoyant float element hole; and
an indicator head hole.

7. The planter of claim 1, further comprising a water level indicator configured to provide visual feedback of a water level within the water reservoir.

8. The planter of claim 7, wherein the water level indicator comprises:
an indicator head;
an indicator stem coupled to the indicator head; and
an indicator buoyant float element coupled to the indicator stem, wherein the indicator buoyant float element and the indicator head are configured to move relative to each other based on a level of water in the water reservoir, and wherein
the indicator head is raised to a maximum height through the indicator head hole of the lid when the water reservoir is empty, and
the indicator buoyant float element is raised to a maximum height through the buoyant float element hole of the lid when the water reservoir is full.

9. The planter of claim 1, wherein the wicking fabric is secured within the frame by recessed channels or structural slots formed in the frame.

10. The planter of claim 1, wherein a portion of the wicking fabric extends into the two or more plant holders to maintain contact with the potting mixture.

11. The planter of claim 1, wherein each plant holder includes perforations configured to permit aeration and moisture transfer.

12. The planter of claim 1, wherein the two or more plant holders are removably secured to the frame using locking bumps or engagement features.

13. The planter of claim 1, wherein the frame includes a bump-out structure configured to support the two or more plant holders at an outwardly angled orientation.

14. The planter of claim 1, wherein the mounting structure comprises:
a wall-engagement slot formed in the frame; and
a wall hook configured to engage the slot.

15. The planter of claim 14, wherein the wall hook comprises a bubble level configured to assist with alignment during installation.

16. The planter of claim 14, wherein the wall hook includes a contoured engagement surface configured to improve stability when the planter is mounted.

17. The planter of claim 1, wherein the frame is configured to support two or more vertically arranged two or more plant holders.

18. The planter of claim 1, wherein the water reservoir is detachable from the planter.
